(19) United States
(12) Patent Application Publication
(10) Pub. No.: US 2006/0052529 A1
(43) Pub. Date: Mar. 9, 2006

(54) Aqueous polymer dispersion and process

(75) Inventors: Marcelo Do Amaral Martins, Rio De Janeiro Rj (BR); Jose M Asua, Donostia-San Sebastian (ES); Hans De Brouwer, Lier (BE); Steven Van Es, Liege (BE)

Correspondence Address: WENDEROTH, LIND & PONACK, L.L.P., 2033 K STREET N. W., SUITE 800, WASHINGTON, DC, 20006-1021, US

(73) Assignee: SURFACE SPECIALTIES S.A., B-1070 BRUXELLES (BE)

(21) Appl. No.: 10/541,806

(22) PCT Filed: Feb. 4, 2004
(86) PCT No.: PCT/EP04/00999

§ 371 Date: Aug. 25, 2005

(30) Foreign Application Priority Data
Feb. 7, 2003 (EP) 03002805.4

(51) Int. Cl. C08G 73/02

(52) U.S. Cl. 524/800

(57) ABSTRACT

The invention relates to a process for the preparation of an aqueous polymer dispersion by mini-emulsion polymerisation comprising the steps of (a) forming a mixture comprising (optionally formed as a first aqueous pre-mixture) water and at least one amphiphilic stabilising polymer having a number average molecular weight Mₙ of 800 to 100,000 and an acid number of 50 to 400 mg KOH/g and (optionally formed as a second organic pre-mixture) at least one hydrophobic co-stabiliser and at least one a,β-ethylenically unsaturated monomer; (b) subjecting this mixture to high stress to form a mini-emulsion comprising stabilised droplets of average diameter from about 10 to about 1000 nm and polymerising the monomer within the droplets. Preferably the mixtures are substantially free of surfactant other than the amphiphilic polymer. Aqueous polymer dispersions so obtained and uses thereof in coatings, films, adhesives and inks are also described.

The present invention relates to a process for the preparation of an aqueous polymer dispersion by mini-emulsion polymerisation, the polymer dispersions so formed and uses thereof.

Aqueous polymer dispersions have been prepared by mini-emulsion polymerisation for several years. This is a method where monomer(s) are dispersed in nano-sized droplets, the dispersed phase of an oil in water emulsion. The monomer emulsions used in mini-emulsion polymerisation have an average droplet diameter from 10 to 1000 nm and can be distinguished from conventional monomer emulsions and emulsion polymerisation processes, where the size of the droplets or micelles is larger from 1 to 10 μm (microns). In a mini-emulsion method each nano-sized droplet becomes the primary locus for nucleation and polymerization which thus occurs in a highly parallel fashion producing polymer latex particles of about the same size as the initial droplets. Mini-emulsion polymerization offers a number of advantages over conventional emulsion polymerization as for example hydrophobic components may be encapsulated or incorporated into the polymer during the polymerisation.

Conventional emulsion polymerisations use monomer(s), water and surfactant as ingredients. Mini-emulsion polymerisation requires the addition of other component(s) to stabilise the small emulsion droplets formed before and during polymerisation. These additional component(s) are usually hydrophobic having no or extremely low water solubility and have good miscibility with the monomer.

WO 00/29451 and U.S. Pat. No. 5,686,518 disclose a series of hydrophobic components that are suitable for the stabilisation of mini-emulsions. These documents teach that surfactants are needed in addition to these hydrophobic components to stabilise both the emulsion droplets and the polymer particles obtained after polymerization. The surfactants used are: sodium lauryl sulfate or other alkylsulfates, sodium dodecyl benzene suffonate or other alkyl or aryl sulfonates, sodium stearate or other fatty acid salts, or polyvinyl alcohol.

U.S. 20021131941 A1 (BASF) (=EP 1191041) describes coloured aqueous polymer dispersions of average partide size below 1000 nm which used as cosmetics. Organic UV absorbers and colorants are major components of these emulsions and their presence significantly effects droplet stability and size distribution within the emulsion and thus the characteristics of the final polymer dispersion obtained. These cosmetic compositions thus behave very differently from colorant free dispersions. This reference addresses the problem that anionic emulsifiers that have been used to stabilise prior art compositions cause skin irritation and teaches using a replacement stabilising system comprising from 0.1 to 20% of at least one non-ionic surface active compound (NS) with from 1 to 50% of at least one amphiphilic polymer (PA) having 0.5 to 10 mol/kg of anionic functional groups, (the percentages by weight of polymer matrix). The amphiphilic polymer does not act as the sole surfactant in this system as non-ionic surfactant must be added to stabilise these dispersion. The use of (non surface active) hydrophobic co-stabilisers of the type described herein is not mentioned in this document. Skin compatible organic amines such as amino alcohols are preferred to neutralise the anionic groups of these amphiphilic polymers. Other differences between U.S. 2002/131941 and the present invention are as follows: The amphiphilic polymers described are limited to those made by addition polymerization. The resultant polymer compositions have a low solids content (<21%) and have high T_{g}. The dispersions exemplified in this reference contain high (about 5%) amounts of coagulated polymer. During polymerisation of these dispersions water soluble free-radical generating compounds are added to the reaction vessel, i.e. will generally be dispersed or dissolved in the continuous (aqueous) phase. In contrast in the process of the present invention free radical generators may be incorporated directly in the organic phase before dispersion.

U.S. Pat. No. 5,952,398 (3M) describes pressure sensitive adhesives (PSA) made by micro-emulsion polymerisation. The PSA has two bi-continuous phases a hydrophobic PSA polymer and a hydrophilic polymer. These compositions are prepared from surfactant stabilised oil in water micro-emulsions. The aqueous continuous phase comprises free-radically ethylenically unsaturated polar amphiphilic or hydrophilic monomer(s) or oligomer(s). The dispersed oil phase comprises micron sized droplets of free-radically ethylenically unsaturated hydrophobic monomer(s) which after polymerisation form large micron sized polymer particles When aqueous polymer dispersions of this document are used to form coatings or thin films, the presence of large amounts of surfactant often leads to defects, for example by aiding migration or clustering of ingredients into hydrophilic pockets. Surfactants also adversely effect desired properties of such coatings or films, by for example increasing water sensitivity or causing other problems like water whitening and efflorescence.

The present invention overcomes some or all of the problems of the prior art by providing a process for the preparation of aqueous dispersions by miril-emulsion polymerisation where the use of undesirable surfactants can be omitted or where their level can be significantly lowered.

Therefore broadly in accordance with the present invention there is provided a process for preparing an aqueous polymer dispersion by mini-emulsion polymerisation, the process comprising the steps of
(a) forming a mixture comprising:
   (i) water;

(ii) at least one amphiphilic stabilising polymer of number average molecular weight (Mₙ) from about 800 to about 100,000 daltons and an acid number from about 50 to about 400 mg KOH/g;
(iii) at least one hydrophobic co-stabiliser; and
(iv) at least one α,β-ethylenically unsaturated monomer;
   where the mixture comprises no more than about 2% by weight of the monomer of the total amount of any further ingredient(s) which act as a surfactant in the mixture;
(b) applying high stress to the mixture from step (a) to form an essentially stable mini-emulsion comprising an aqueous continuous phase and dispersed therein stabilised droplets of average diameter from about 10 to about 1000 nm, the droplets comprising the hydrophobic co-stabiliser and the monomer
(c) polymerising the monomer within the droplets;

Optionally the process of the invention is subject to at least one of the following provisos:
(w) the mixture in step (a) comprises less than 0.1% of the total amount any non-ionic surface active compounds;
(x) hydrophobic co-stabiliser(s) do not also act as surfactants (i.e. they are substantially free from the interface between the dispersed organic phase and continuous aqueous phase)
(y) the hydrophobic co-stabiliser(s) are substantially colourless; and/or
(z) any acid groups on the amphiphilic stabilising polymer are neutralised by at least one strong base, optionally selected from an alkali metal hydroxide and ammonia.

It will be appreciated that the polymerisation as described herein may be performed as a batch, continuous and/or semi-continuous process. It is also possible that additional monomer(s) may be added to the continuous phase to diffuse into the dispersed droplets as needed. For example if it is desired to control the relative concentration of monomer(s) in the dispersed droplets (e.g. to prevent significant changes in the composition of the resultant polymer as polymerisation proceeds) then suitable amounts of one or more monomer(s) may be added to the mixture at appropriate times during the process.

It was found that the use of an amphiphilic stabilising polymer as defined herein permits to prepare stable mini-emulsions without the need to add large amounts, preferably any, conventional surfactants, such as alkyl, aryl, alkylaryl and arylalkylsulfates and sulfonates.

The amphiphilic stabilising polymer used in the process according to the invention exhibits an adequate balance of hydrophobicity and hydrophilicity such that it is suited for the stabilisation of oil-in-water emulsions. Preferred amphiphilic stabilising polymers comprise those polymers derived from a combination of hydrophobic monomers and hydrophilic monomers, the polymers incorporating acid functions or functions leading thereto.

Preferably the mixture formed in step (a) comprises less than about 1%, more preferably less than about 0.5%, most preferably less than 0.1% of additional surfactants. Conveniently the mixture of step (a) is substantially free of additional surfactants. Advantageously the sole component in the mixture of step (a) that may act as a surfactant in the mini-emulsions formed in step (b) is the amphiphilic stabilising polymer(s).

The hydrophobic co-stabilisers used herein do not act as conventional non-ionic surfactants as they are soluble in the hydrophobic monomers but highly insoluble in water. The hydrophobic co-stabiliser(s) are present mainly, preferably substantially only, in the hydrophobic phase and not at the interface between the hydrophobic and hydrophilic phases as would be the case for species acting as a conventional non-ionic surfactant. The hydrophobic co-stabilisers act to stabilise the dispersed monomers.

In a preferred process of the invention it is unnecessary to use additional surfactants, such as additional non-ionic surfactants, to prepare stable dispersions.

The amphiphilic stabilising polymer is more preferably a copolymer derived from addition polymerisation of one or more ethylenically unsaturated hydrophobic monomers such as styrene, (meth)acrylic esters, isobutylene and derivatives thereof, with one or more ethylenically unsaturated hydrophilic monomers such as carboxylic monomers (for example acrylic acid, methacrylic acid, itaconic acid), sulfonic acid monomers or their salts (for example styrenesulfonic acid and 2-acrylamido-2-methyl-propane sulfonic acid), phosphate monomers (for example ethylene glycol methacrylate phosphate), phosphonate monomers (for example vinylphosphonic acid), anhydrides (for example maleic anhydride), the latter being optionally hydrolysed or modified by an alcohol or amine.

Conveniently the amphiphilic polymers are substantially uncoloured so the resultant dispersions may also be uncoloured.

Other amphiphilic polymers suitable for being used in the process according to the invention are those derived from step polymerisation such as polyurethanes and polyesters containing pendant acid functions. Suitable polyurethane polymers are those obtained from a polyurethane prepolymer which is the reaction product of:
(i) at least one polyisocyanate (such as isophorone diisocyanate, dicyclohexylmethane diisocyanate and/or tetramethylxylilenediisocyanate),
(ii) at least one organic compound containing at least two reactive groups which can react with isocyanates (such as polyester polyols, polyether polyols and/or polycarbonate polyols any of which have a preferred number average molecular weight (Mₙ) from about 400 to about 5,000 daltons), and
(iii) at least one alcohol or polyol which is can react with an isocyanate group and which contain additional functional groups which can provide good dispersion in water and which can provide acid functionality. Such an alcohol or polyol may have functional groups such as anionic salt groups or similar precursors which may be subsequently converted to such anionic salt groups, such as carboxylic or sulfonic acid groups. The carboxylate salt groups incorporated into the isocyanate-terminated polyurethane prepolymers which may be used in the method of the present invention may be derived from hydroxycarboxylic acids for example those represented by Formula 1
   (HO)ₓR(COOH)_{y} Formula 1, where
R represents a straight or branched hydrocarbon residue of 1 to 12 carbon atoms, and
x and y are independently integers from 1 to 3.

More preferred hydroxycarboxylic acids are α,α-dimethylolalkanoic acids, (i.e. where x=and y=1 in Formula 1), such as 2,2-dimethylolpropionic acid.

More preferred amphiphilic polymers comprise copolymers derived from styrene and maleic anhydride and/or copolymers derived from styrene, α-methyl styrene and acrylic acid.

Conveniently the amphiphilic polymers used in the process of the present invention have a solubility in the aqueous phase of the mini-emulsion (as measured at 25° C.) of at least about 1×10⁻² g/l, more conveniently at least about 1×10⁻¹ g/l, and most conveniently at least about 1 g/l.

Preferred amphiphilic polymers have a Mₙ from about 900 to about 50,000 daltons, more preferably from about 1,000 to about 25,000.

Preferred amphiphilic polymers have an acid number from about 100 to about 350 mg KOH/g, more preferably from about 150 to about 300 mg KOH/g. Acid number as used herein is defined as the amount of potassium hydroxide (expressed in milligrams) needed to completely neutralise one gram of the polymer.

The amount of amphiphilic polymer used in the process of the present invention may generally be from about 0.5% to about 15% by weight of monomer (all weight percentages of amphiphilic stabilising polymer are expressed relative to the total weight of α,β-ethylenically unsaturated monomers used). Preferably the amount of amphiphilic stabilising polymer used is from about 1% to about 8%, more preferably from about 2% to about 5% by weight of monomer.

The hydrophobic co-stabiliser(s) used in the process of the invention are both highly water insoluble and highly soluble in the α,β-ethylenically unsaturated monomer(s). Conveniently the hydrophobic co-stabilisers have a solubility in water (measured at 25° C.) of less than about 5×10⁻⁵ g/l, more conveniently less than about 5×10⁻⁶ g/l

Preferred hydrophobic co-stabilisers comprise one or more of the following:
hydrocarbons, more preferably alkanes or cycloalkanes, most preferably of at least 12 carbon atoms (such as hexadecane and/or octadecane);
long chain alcohols (such as hexadecanol and/or octadecanol);
halogenated hydrocarbons,
organosilicon compounds,
long-chain esters,
oils, more preferably vegetable oils (such as olive oil),
hydrophobic dye molecules,
capped isocyanates,
oligomeric and/or polymeric products of polymerisation, polycondensation or polyaddition, such as polymeric co-stabilisers (e.g. those described in U.S. Pat. No. 5,686,518, the contents of which are hereby incorporated by reference); and/or suitable mixtures and/or combinations thereof.

Conveniently the hydrophobic co-stabiliser(s) is not strongly coloured and except in the further aspect of the process described below does not react during polymerisation.

In a further aspect of the process of the present the invention, the hydrophobic co-stabiliser(s) can be reactive and can be used either with or without additional non-reactive hydrophobic co-stabiliser(s). Reactive hydrophobic co-stabilisers denote those co-stabilisers that participate in the subsequent polymerisation reaction.

Preferred reactive hydrophobic co-stabilisers comprise one or more of the following:
hydrophobic (co)monomers, more preferably acrylates, most preferably stearyl acrylate and/or long chain (meth)acrylates,
macromonomers;
hydrophobic chain transfer agents, more preferably dodecyl mercaptane, octadecyl mercaptane and/or other long chain mercaptanes;
hydrophobic initiators, more preferably 2,5-dimethyl-2-5-di(2-ethylhexanoylperoxy) hexane and other long chain (hydro)peroxides, and/or azo initiators and/or suitable mixtures and/or combinations thereof.

Usefully the hydrophobic co-stabiliser(s) are selected from C₁₂₋₂₄alkanes (especially hexadecane), C₁₂₋₂₄alcohols, C₁₈₋₂₂acrylates (especially the mixture of acrylates available commercially from Atofina under trade name Norsocryl™ A-1822); and/or mixtures thereof.

If hydrophobic (co)monomers are used which function both as the hydrophobic co-stabiliser and the α,β-ethylenically unsaturated monomer, the amount of such hydrophobic (co)monomer(s) can be as high as about 70% by weight. Generally the hydrophobic costabiliser may be added in an amount from about 0.05% to about 40% by weight. Especially when the hydrophobic co-stabiliser is not a (co)monomer, the amount of co-stabiliser is preferably from about 0.1% to about 10%, more preferably from about 0.2% to about 8% and most preferably from about 0.5% to about 5% by weight. The weights of hydrophobic co-stabiliser used herein are calculated relative to the total weight of the mixture prepared in step (a) of the process of the invention.

Usefully the α,β-ethylenically unsaturated monomers used in the process of the invention have a low solubility in water, preferably (measured at 25° C., as a percentage of grams of dissolved monomer per 100 grams of water) less than about 15%, more preferably less than about 5%, and most preferably less than about 3%.

Preferred α,β-ethylenically unsaturated monomers comprise one or more of the following and/or mixtures and combinations thereof:
alkyl (meth)acrylates, more preferably methyl acrylate, methyl methacrylate, ethyl acrylate, ethyl methacrylate, butyl acrylate, butyl methacrylate, 2-ethylhexyl acrylate, cyclohexyl methacrylate, 2-ethylhexyl methacrylate, stearyl methacrylate, isobornyl methacrylate and/or lauryl methacrylate, most preferably methyl methacrylate, methyl acrylate, n-butyl acrylate, ethyl acrylate and/or, 2-ethylhexyl acrylate,
polymerisable aromatic compounds; more preferably styrenes, most preferably styrene,
α-methyl styrene, vinyl toluene and/or tbutyl styrene,
polymerisable nitriles; more preferably acrylonitrile and/or methacrylonitrile,
polymerisable amide compounds,
α-olefin compounds such as ethylene,
vinyl compounds; more preferably vinyl esters (most preferably vinyl acetate, vinyl propionate and/or longer chain vinyl ester homologues) vinyl ethers, vinyl halides (most preferably vinyl chloride) and/or vinylidene halides,
diene compounds more preferably butadiene and/or isoprene.
α,β-ethylenically unsaturated monomers comprising fluorine and/or silicon atoms, more preferably 1H, 1H, 5H-octafluoropentyl acrylate and/or trimethylsiloxyethyl acrylate.

Advantageously the α,β-ethylenically unsaturated monomers are selected from styrenes, acrylates, methacrylates, vinyl and vinylidene halides, dienes, vinyl esters and mixtures thereof; more advantageously from methyl methacrylate, styrene, vinyl acetate, methyl acrylate, butyl acrylate, ethyl acrylate, 2-ethylhexyl acrylate, butadiene and vinyl chloride.

The amount of α,β-ethylenically unsaturated monomers used in the process of the invention may be generally from about 10% to about 70%, preferably from about 18% to about 60% by weight calculated relative to the total weight of the mixture prepared in step (a) of the process of the invention.

According to a still further aspect of the process of the present invention, in addition to the α,β-ethylenically unsaturated monomer(s) one or more water-soluble monomers (denoted herein as secondary monomers) may be added to the mixture formed during step (a). These optional secondary monomers may comprise ethylenically unsaturated organic compounds which can undergo addition polymerisation. Preferred secondary monomers have a water solubility (measured at 25° C., as a percentage of grams of dissolved monomer per 100 grams of water) higher than about 15%. Conveniently secondary monomers may be used only in the presence of at least one α,β-ethylenically unsaturated monomer and only in small percentages in such a monomer mixture. Preferably the amount of optional secondary monomer in such a monomer mixture is less than about 6%, more preferably from about 0.1% to about 4%, and most preferably from about 0.1% to about 2% by weight relative to the total monomer weight.

Preferred secondary monomers are acrylic acid, methacrylic acid, 2-sulfoethyl methacrylate, and/or maleic anhydride. Using secondary monomers in the process of the invention can impart desired properties to the coatings produced from the resultant polymer dispersions.

The mixture formed in step (a) may also contain one or more components that modify pH. For example if the stabilising amphiphilic polymer comprises carboxylic acid groups, it may be necessary to prepare and polymerise the mini-emulsion at a high pH for the stabilising polymer to exhibit the desired amphiphilcity. For such carboxylic acid functional polymers a suitable pH range may be from about 6.0 to about 10.0, preferably from about 7.5 to about 10.0, depending on the nature of the other components of the amphiphilic polymer. When the stabilising polymer comprises acid functions derived from sulfonic acid, sulphate, phosphate or phosphonate, a suitable range of pH may be from about 2.0 to about 10.0.

Compounds capable of adjusting pH may comprise: ammonia, amines (for example triethyl amine, triethanol amine, dimethylamino hydroxypropane), carbonate salts (for example sodium carbonate), bicarbonate salts (for example sodium bicarbonate), hydroxides (for example sodium hydroxide) and/or oxides (for example calcium oxide). Preferred pH-adjusting compounds are strong bases, optionally selected from an alkali metal hydroxides (such as sodium hydroxide) and/or ammonia.

The pH-adjusting compound may be added during step (a) of the process of the invention, preferably before the amphiphilic polymer is added to the mixture.

Each steps of the method of the invention may be independently carried out under any suitable conditions selected depending on the reagents used. Conveniently any of the steps may be carried out at any suitable temperatures between the freezing point and the boiling point of the various mixture(s) and the components present therein, more conveniently from about 0° C. to about 100° C., most conveniently at about ambient temperature. Conveniently the steps may be carried out under pressures from about 0.01 to about 100 atmosphere, more conveniently at about atmospheric pressure.

In a yet other aspect of the process of the present invention, in step (a) the mixture may be conveniently formed by mixing a first pre-mixture comprising the amphiphilic stabilising polymer and water with a second pre-mixture comprising the hydrophobic co-stabiliser and the α,βethylenically unsaturated monomer(s).

The first pre-mixture may be prepared by adding the amphiphilic stabilising polymer to water, preferably at a temperature from about 0° C. to about 100° C., followed by the addition of one or more optional ingredients (as described and in the amounts described herein): such as surfactant(s), secondary water soluble monomer(s); pH adjusting compound(s) and/or polymerisation initiator(s).

If the first pre-mixture is prepared using an amphiphilic stabilising polymer comprising carboxylic acid function(s) then pH-adjusting compound(s) may be added to adjust the solubility (as measured at 25° C.) of the amphiphilic polymer in the first pre-mixture (i) to at least about 1×10⁻² g/l, more preferably at least about 1×10⁻¹ g/l, and most preferably at least about 1 g/l. It is preferred to add the pH-adjusting compound to the amphiphilic polymer before the polymer is added to the water and to any optional additional components of the first pre-mixture.

The second pre-mixture may be prepared by adding the desired amount of hydrophobic co-stabiliser to the α,β-ethylenically unsaturated monomer(s), preferably under gentle agitation. It is also preferred to prepare the second pre-mixture at room temperature, more preferably until a clear solution is obtained. Optionally one or more secondary water-soluble monomers (as described herein) and/or a polymerisaton initiator may also be added to the second pre-mixture.

The formation of the mixture in step (a) preferably is performed at a temperature of from about 0° C. to about 100° C., preferably at about ambient temperature.

Preferably in step (b) of the process of the invention, the mixture of step (a), is mixed until a mini-emulsion is formed which comprises stabilised droplets having a average diameter from about 10 to about 900 nm, more preferably from about 50 to about 500 nm, most preferably from about 80 to about 450 nm, for example from about 100 to about 430 nm.

Droplet size was measured herein using samples of the mini-emulsion diluted with delonised water (or preferably with deionised water saturated with the monomer(s) present in the mini-emulsion). Average droplet diameter of the sample was determined directly within 15 minutes using dynamic light scattering, for example on a Coulter™ N4 Plus or a Nicomp 380 ZLS device.

In step (b) the mixture is mixed under high stress. Stress is described as force per unit area. One manner in which stress is exerted is by shear. Shear means that the force is such that one layer or plane moves parallel to an adjacent one. Stress can also be exerted from all sides as a bulk, compression stress, such that stress is exerted without almost any shear. Another manner of exerting stress is by cavitation, which occurs when the pressure within a liquid is reduced enough to cause vaporisation. The formation and collapse of the vapour bubbles occurs violently over a short time period and produces intense stress. Another manner of applying stress is the use of ultrasonic energy. It is preferred to use an equipment capable of producing localised high shear, preferably along with moderate bulk mixing. More preferably high shear mixing is obtained by using ultrasound treatment, colloid mill and/or homogenizer.

The monomer mini-emulsions may be usefully formed at any temperature between the freezing point and the boiling point of the mixture and the components present therein, preferably from about 20 to about 50° C., more preferably from about 25 to about 40° C., most preferably about ambient temperature.

Step (b) of the process of the invention produces a essentially stable mini-emulsion comprising an aqueous continuous phase and a dispersed phase of droplets which comprise the α,β-ethylenically unsaturated monomer(s) and the hydrophobic costabiliser. Without wishing to be bound by any mechanism it is believed that a major part of (preferably substantially all) the amphiphilic stabilising polymer may be located at or near the interface between the dispersed and continuous phase. The solubility of the stabilising polymer in the monomer, when the stabilising polymer is in the deprotonated state, is preferably less than about 2%, more preferably less than about 1%, by weight based on the total weight of monomer.

Essentially stable denotes a mini-emulsion with a shelf life sufficiently long so the monomer(s) dispersed within the emulsion can be polymerised within the droplets before the emulsion destabilises and the phases have had time to separate. Mini-emulsions obtained by the process of the invention generally have a shelf life of more than 24 hrs, often more than several days.

In step (c) of the process of the invention, the monomer(s) within the droplets are polymerised. The monomer(s) is generally polymerised under free radical polymerisation conditions, preferably in the presence of a free radical initiator. The polymerisation initiator may be either a water-soluble or an oil soluble compound. Suitable free radical initiators are well known in the art and comprise (as a non limiting list) for example, organic peroxides such as benzoyl peroxide, lauroyl peroxide, 2,5-dimethyl 2,5-di(2-ethylhexanoylperoxy) hexane and dicumyl peroxide; inorganic persulfates such as potassium, sodium and/or ammonium persulfate; and azo initiators such as azobis-(isobutyro nitrile) (AlBN) and azobis (1-cyclohexanecarbonitrile); and/or redox pairs such as those comprising Fe²⁺/H₂O₂, ROH/Ce⁴⁺ (where R is an organic group such as C₁₋₆alkyl or C₅₋₆aryl) and/or K₂S₂O₈/Fe²⁺ either paired with for example ascorbic acid and/or one or more bisulfites. The optional polymerisation initiator(s) which may also be added to the first and/or second pre-mixture(s) formed in step (a) may also be selected from those listed herein.

The free-radical initiator may be added after, before and/or during step (b). Where optional first and second pre-mixtures are prepared in step (a) and the solubility of the initiator in the second pre-mixture is higher than in the first, the initiator is preferably added to the second pre-mixture. However if the initiator is more soluble in the first pre-mixture, it is preferred to add the initiator at the end of step (a) after the mixture has been formed or more preferably to the mini-emulsion obtained at the end of step (b).

During the polymerisation step (c) of the invention, to keep the stabilising polymer in an amphiphilic state it may be necessary to add further pH adjusting compound as described for step (a), especially where pH drops during polymerisation. Such a drop in pH may be caused by the dissociation of persulfate initiators (for example ammonium persulfate) and/or as any pH adjusting compound already present in the mixture evaporates (for example when ammonia is used). The pH-adjusting compound(s) added during step (c) may be the same or different to any added during step (a).

The polymerisation of step (c) may be carried out over a broad temperature range depending on the choice of initiator, preferably from about 20 to about 90° C., more preferably from about 25 to about 80° C., for example about 70° C.

The polymerisation of step (c) is usually conducted over a period from about 10 min to about 24 hrs, more usually from about 2 to about 10 hours, most usually from about 4 to about 6 hours.

The present invention also relates to an aqueous polymer dispersion (also referred to herein as a polymer emulsion, mini-emulsion and/or polymer latex) obtained and/or obtainable by the processes of the invention as described herein, and to (dry) polymers collectable from such dispersions.

Broadly in a still yet other aspect of the present invention provides an aqueous polymer dispersion comprising a matrix of polymer particles formed from at least one α,β-ethylenically unsaturated monomer, the particles having an average diameter from about 10 to about 1000 nm, and homogenously dispersed with the polymer matrix there is: (i) at least one amphiphilic stabilising polymer of number average molecular weight (Mₙ) from about 800 to about 100,000 daltons and an acid number from about 50 to about 400 mg KOH/g; and (ii) optionally at least one hydrophobic co-stabiliser.

Optionally the polymer dispersion of the invention subject to at least one of the following provisos:
(w) the dispersion comprises less than 0.1% of total amount any non-ionic surface active compounds;
(x) the dispersion has a solids content of at least 22% by weight;
(y) the optional hydrophobic costabiliser(s) are substantially colourless; and/or
(z) any acid groups on the amphiphilic stabilising polymer are neutralised by at least one strong base, optionally selected from an alkali metal hydroxide and ammonia.

The aqueous polymer dispersion of invention may comprise polymer particles having an average diameter approximately the same as the average size of the droplets in the mini-emulsions from which they were formed.

Preferred polymer lattices of the invention have an average diameter from about 10 to about 900 manometers, more preferably from about 50 to about 500 nm, most preferably from about 50 to about 400 nm, for example from about 80 to about 350 nm.

Preferred aqueous polymer dispersions of the invention have a solids contents from about 25% to about 60%, more preferably from about 28% to about 50% by weight of the dispersion.

Polymer lattices of the invention may have a good stability, preferably of at least 6 months; and have similar uses to known lattices. Preferred uses comprise preparing decorative and protective coatings, films, pressure sensitive adhesives, inks, glues, stains, varnishes, constructive adhesives and the like.

Coatings and films obtained from a latex of the invention may have an improved water resistance and a lower water absorption. They may also exhibit less whitening when exposed to water, an improved gloss, a better blocking resistance and/or a high film hardness.

Further aspects of the present invention are given in the claims.

The following non-limiting examples are described to illustrate the invention.

### EXAMPLE 1

1(a)(i) Preparing a First Pre-Mixture (aq. Solution of Amphiphilic Stabilising Polymer):

A copolymer (60 g of the styrene, α-methyl styrene and acrylic acid copolymer of Mₙ=6500 and acid number from 193 to 215 mg KOH/g available commercially from Rohm & Haas under the trade mark Morez™101) was added whilst stirring to a mixture of 17.9 g ammonia (25% w/w) and 125 g demineralised water. The resultant mixture was then heated to 70° C. and stirred until the copolymer had completely dissolved. The resulting solution had a solid content of 29.7% (w/w).

1(a)(ii) Preparing a Second Pre-Mixture (Organic Solution of Co-Stabiliser & Monomer

A hydrophobic co-stabiliser (0.29 g of hexadecane) was dissolved in an α,β-ethylenically unsaturated monomer (14.4 g of styrene).

1(a) Forming a Mixture:

The first pre-mixture from step 1(a)(i) (2.28 g) was diluted with 57.6 g demineralised water. The second pre-mixture from step 1(a)(ii) was added directly to the diluted first pre-mixture as the resultant mixture was stirred for 10 minutes using a magnetic stirring bar at 1000 rpm.

1(b) Preparing a Mini-Emulsion:

The mixture from the previous step 1(a) was subject to high stress by treating with ultrasound for 10 minutes (produced from the ultrasound device available commercially under the trade designation Branson Sonifier 450 with the output control set at 8 and a duty cycle of 90%). The resulting mini-emulsion had a droplet size of approximately 191 nm.

1(c) Polymerising the Monomers:

Potassium persulfate (0.07 g) was dissolved in the mini-emulsion from the step 1(b). The resultant mixture was then transferred to a sealed glass bottle and placed into water bath at 70° C. for 6 hours. The resulting polymer dispersion had a particle size of 176 nm and 1.4% of the polymer was coagulated.

### EXAMPLE 2

Example 1 was repeated except that in preparing the mini-emulsion in step (b) the mixture was treated with ultrasound in the same manner for 5 minutes. The mini-emulsion formed had a droplet size of approximately 416 nm. The resulting polymer dispersion had a particle size of 124 nm and 7.6% of the polymer was coagulated.

### EXAMPLE 3

3(a)(i) Preparing a First Pre-Mixture (aq. Solution of Amphiphilic Stabilising Polymer)

A copolymer (80 g of the styrene-maleic anhydride copolymer of acid number from 165 to 205 mg KOH/g available commercially from Atofina under the trade designation SMA1440) was added whilst stirring to a mixture of 21 g ammonia (25% w/w) and 400 g demineralised water. The resultant mixture was then heated to 70° C. and stirred until the SMA resin was largely dissolved and then 100 g of further demineralised water was added. The aqueous solution was decanted from the undissolved SMA resin to give a solution of 8.3% (w/w) solids.

3(a)(ii) Preparing a Second Re-Mixture (Organic Solution of Co-Stabiliser & Monomer)

A hydrophobic costabiliser (5.72 g of hexadecane) and α,β-ethylenically unsaturated monomers (200.2 g of methyl methacrylate and 85.8 g of butyl acrylate) were gently stirred together. Then 2.86 g of 1,1′-azobis(Iyclohexanecarbonitrile) (available commercially from Wako under the trade designation V40) was dissolved in this mixture.

3(a) Forming a Mixture:

Demineralised water (636 g) and a non-ionic surfactant (0.44 g of the mixture of ethoxylated linear fatty alcohols available commercially from Cognis under the trade mark Disponil™A3065) were mixed together in a 12 litre beaker. A first pre-mixture of SMA (68.9 g prepared analogously to that described in step 3(a)(i)) was added to the mixture of water and surfactant. The second pre-mixture from step 3(a)(ii) was directly added slowly whilst the resultant mixture was stirred continuously for 30 minutes.

3(b) Preparing a Mini-Emulsion:

The mixture obtained from the previous step 3(a) was added to a beaker in water bath. The bulk mixture was stirred using a magnetic stirrer. The mixture was cooled in the bath whilst it was subjected to high stress by being treated with ultrasound for 10 minutes (produced from the 400 W ultrasound probe available commercially under the trade designation Dr. Hielscher UP400S, with an amplitude setting of 60% at a duty cycle of 0.9). A mini-emulsion was obtained.

3(c) Polymerisin: the Monomers

The mini-emulsion obtained from step 3(c) was transferred to a 1 litre double jacketed glass reactor connected to a water bath and equipped with a mechanical anchor stirrer. The mixture was heated to 70° C. and this temperature was maintained for 4 hours. The mixture was then cooled and filtered. The resulting polymer dispersion contained 28.5% of solids and had an average particle size of 195 nm.

### EXAMPLE 4

4(a)(i) Preparing a First Pre-Mixture (aq. Solution of Amphiphilic Stabilising Polymer)

A copolymer (60 g of the styrene, α-methyl styrene and acrylic acid copolymer of Mₙ=1200 and acid number of 235 mg KOH/g available commercially from Rohm & Haas under the trade mark Morez™300 resin) was added whilst stirring to a mixture of 20.5 g ammonia (25% w/w) and 125 g demineralised water. The mixture was then heated to 70° C. and stirred until the copolymer had completely dissolved. The resulting solution had 29.3% (w/w) solids.

Steps 4(a)(ii), 4(a), 4(b) & 4(c). Preparing Second Pre-Mixture, Mixture & Mini-Emulsion, & Polymerisation

A polymer dispersion was prepared as described in Example 1 steps 1(a)(ii), 1(a), 1(b) & 1(c) except first pre-mixture from the previous step 4(a)(i) was used to replace the first pre-mixture from step 1 (a)(i) of Example 1. The average droplet size of the mini-emulsion obtained in step 4(b) was approximately 177 nm. The resultant polymer dispersion obtained had a particle size of 163 nm and 1.3% of the polymer was coagulated.

### EXAMPLE 5

5(a)(i) Preparing a First Pre-Mixture (aq. Solution of Amphiphilic Stabilising Polymer)

A first pre-mixture was prepared as described in Example 1(a)(i)

5(a)(ii) Preparing a Second Pre-Mixture (Organic Solution of Co-Stabiliser & Monomer)

Hydrophobic co-stabiliser (0.59 g of hexadecane and 0.59 g of the 2,5-dimethyl 2,5-di(2-ethylhexanoylperoxy)hexane available commercially from Atofina under the trade mark Luperox™256) were dissolved in an α,β-ethylenically unsaturated monomer (29.6 g butyl acrylate) to form a second pre-mixture.

5(a) Forming a Mixture:

The first pre-mixture (1.97 g from Example 1 (a)(i)) was mixed with 44.2 g water and the second pre-mixture from step 5(a)(ii) was added while the mixture was stirred using a magnetic stirring bar for 10 minutes.

5(b) Preparing a Mini-Emulsion:

The mixture from the previous step 5(a) was added to a beaker in an ice bath and the mixture was cooled in the bath whilst it was subjected to high stress by being treated with ultrasound for 5 minutes (produced from the ultrasound device available commercially under the trade designation Branson Sonifier 450 with the output control at 8 and a duty cycle of 80%) to produce a mini-emulsion of average droplet size approximately 165 nm.

5(c) Polymerising the Monomers

The mini-emulsion from step 5(c) was transferred to a sealed glass bottle and submerged in a water bath at 70° C. for 6 hours. The resultant polymer dispersion had an average particle size of 310 nm, a solids content of 39.7% (w/w), and it was found only a low amount of the polymer had coagulated.

### EXAMPLE 6

6(a)(i) Preparing a First Pre-Mixture (aq. Solution of Amphiphilic Stabilising Polymer)

A first pre-mixture was prepared as described in Example 1 (a)(i)

6(a)(ii) Preparing a Second Pre-Mixture (Organic Solution of Co-Stabiliser & Monomer)

Hydrophobic co-stabiliser (0.31 g of hexadecane) was dissolved in α,β-ethylenically unsaturated monomer (14.4 g of butyl acrylate) to form a second pre-mixture.

6(a) Preparing a Mixture

The first pre-mixture (2.28 g from Example 1(a)(i)) was mixed with 57.6 g of demineralised water. Then the second pre-mixture from step 6(a)(ii) was added to the diluted first pre-mixture over 10 minutes whilst the mixture was stirred with a magnetic stirring bar at 1000 rpm.

6(b) Preparing a Mini-Emulsion

The mixture obtained from the previous step 6(a) continued to be stirred to mix the bulk whilst the mixture was subjected to high stress by being treated with ultrasound for 10 minutes (produced from the 400 W ultrasound probe available commercially under the trade designation Dr. Hielscher UP400S, with an amplitude setting of 90% at a duty cycle of 0.8). A mini-emulsion was obtained.

6(c) Polymerising the Monomers

Ammonium persulfate (0.07 g) was dissolved in the mini-emulsion from step 6(b). The mixture was then transferred to a 100 ml three-necked glass reactor; equipped with a reflux condenser and oil bath. The mixture was heated to 70° C. and this temperature was maintained for 6 hours. The resulting polymer dispersion had an average particle size of 134 nm and only 0.5% of the polymer coagulated.

### EXAMPLE 7

7(a)(i) Preparing a First Pre-Mixture (aq. Solution of Amphiphilic Stabilising Polymer)

A first pre-mixture was prepared as described in Example 1 (a)(i)

7(a)(ii) Preparing a Second Pre-Mixture (Organic Solution of Co-Stabiliser & Monomer)

Hydrophobic co-stabiliser (0.72 g of hexadecane and 0.72 g of the 2,5dimethyl 2,5-di(2-ethylhexanoyiperoxy)hexane available commercially from Atofina under the trade mark Luperox™256) were dissolved in an α,β-ethylenically unsaturated monomer (36.1 g methyl methacrylate) to form a second pre-mixture.

7(a) Preparing a Mixture

The first pre-mixture (2.4 g from Example 1(a)(i)) was mixed with 35.1 g of demineralised water. Then the second pre-mixture from step 7(a)(ii) was added to the diluted first pre-mixture whilst the mixture was stirred for 10 minutes.

7(b) Preparing a Mini-Emulsion

The mixture obtained from the previous step 7(a) was added to a beaker in an ice bath and the mixture was cooled in the bath to keep the temperature low enough prevent polymerisation whilst it was subjected to high stress by being treated with ultrasound for 10 minutes (produced from the ultrasound device available commercially under the trade designation Branson Sonifier 450 with the output control at 8 and a duty cycle of 80%). A mini-emulsion was obtained with an average droplet diameter of 128 nm.

7(c) Polymerising the Monomers

The mini-emulsion from step 7(b) was transferred into a glass bottle which was submerged in a water bath of 70° C. and polymerisation was continued for 6 hours at this temperature. The resulting polymer dispersion had an average particle diameter of 245 nm and 49.8% solids. The amount of coagulated polymer was negligible.

### EXAMPLE 8

8(a)(i) Preparing a First Pre-Mixture (aq. Solution of Amphiphilic Stabilising Polymer)

A first pre-mixture was prepared as described in Example 3(a)(i)

8(a)(ii) Preparing a Second Pre-Mixture (Organic Solution of Co-Stabiliser & Monomer)

Hydrophobic co-stabiliser (5.7 g of the mixture of C₁₈₋₂₂acrylates available commercially from Atofina under the trade mark Norsocryl™A-18-22) were dissolved in α,β-ethylenically unsaturated monomers (a mixture of 96 g methyl methacrylate and 41 g butyl acrylate) to form a second pre-mixture.

8(a) Preparing a Mixture

The first pre-mixture (68.9 g from Example 3(a)(i)) and 10 g of a 5% solution of sodium hydroxide in water were added to 275 g of demineralised water. Then the second pre-mixture from step 8(a)(ii) was added directly to the diluted first pre-mixture whilst the mixture was stirred for 10 minutes.

8(b) Preparing a Mini-Emulsion

The mixture from the previous step 8(a) continued to be stirred with a magnetic stirrer to mix the bulk whilst the mixture was subjected to high stress by being treated with ultrasound for 10 minutes (produced from the 400 W ultrasound probe available commercially under the trade designation Dr. Hielscher UP400S with an amplitude setting of 60% at a duty cycle of 0.9). A mini-emulsion was obtained

8(c) Polymerising the Monomers

The mini-emulsion from step 8(b) was transferred to a one litre double jacketed glass reactor connected to a water bath and equipped with a mechanical anchor stirrer. Ammonium persulfate (0.8 g) was added to the mini-emulsion and the mixture was heated to 70° C. and this temperature was maintained for 6 hours, after which the mixture was cooled and filtered. The resulting polymer dispersion contained 28.4% of solids and had a average particle size of 123 nm. Samples taken of the mixture during polymerisation after 2 and 4 hours had average particle diameters of 114 and 119 nm respectively.

### EXAMPLE 9

9(a)(i) Preparing a First Pre-Mixture (aq. Solution of Amphiphilic Stabilising Polymer)

A first pre-mixture was prepared as described in Example 3(a)(i)

9(a)(ii) Preparing a Second Pre-Mixture (Organic Solution of Co-Stabiliser & Monomer)

Hydrophobic costabiliser (20 g of the mixture of C₁₈₋₂₂acrylates available commercially from Atofina under the trade mark Norsocryl™A-18-22) and a polymerisation initiator (3.8 g of dilauroyl peroxide, available commercially from Akzo Nobel under the trade mark Laurox S™) were dissolved in α,β-ethylenically unsaturated monomers (a mixture of 250 g methyl methacrylate and 250 g butyl acrylate) to form a second pre-mixture.

9(a) Preparing a Mixture

The first pre-mixture (241 g from Example 3(a)(i)) and 20 g of a 5% solution of sodium hydroxide in water were added to 1031 g of demineralised water. Then the second pre-mixture from step 9(a)(ii) was added directly to the diluted first pre-mixture whilst the resultant mixture was stirred for 10 minutes.

9(b) Preparing a Mini-Emulsion

The coarse emulsion from the previous step 9(a) was subjected to high shear using a high shear mixing device (that available commercially from Microfluidics™ under the trade designation M-110Y Microfluidizer® processor and equipped with a F20Y interaction chamber and H30Z auxiliary process module). The emulsion was passed through the device three times and the product outlet was cooled in order to prevent polymerization. A mini-emulsion was obtained.

9(c) Polymerising the Monomers

The mini-emulsion from step 9(b) was transferred to a 2.5 litre double jacketed glass reactor connected to a water bath and equipped with a mechanical anchor stirrer. The mini-emulsion was heated to 70° C. and this temperature was maintained for 6 hours and then the mixture was cooled and filtered. The resulting polymer dispersion contained 28.0% solids and had an average particle size of 116 nm. The amount of coagulated polymer was negligible.

Comp A (Comparative Example):

Example 6 was repeated without subjecting the mixture formed in step 6(a) to the high stress by treatment with ultrasound (i.e. step 6(b) was omitted). The resulting polymer dispersion had an average particle size of 930 nm, with 3.3% of the polymer coagulated. The dispersion was unstable as after 24 hours partial phase separation was observed.

1. A process for preparing an aqueous polymer dispersion by mini-emulsion polymerisation, the process comprising the steps of
(a) forming a mixture comprising:
(i) water;
(ii) at least one amphiphilic stabilising polymer of number average molecular weight (Mₙ) from about 800 to about 100,000 daltons and an acid number from about 50 to about 400 mg KOH/g;
(iii) at least one hydrophobic co-stabiliser; and
(iv) at least one α,β-ethylenically unsaturated monomer;
where the mixture comprises no more than about 2% by weight of the monomer of the total amount of any further ingredient(s) which act as a surfactant in the mixture;
(b) applying high stress to the mixture from step (a) to form an essentially stable mini-emulsion comprising an aqueous continuous phase and dispersed therein stabilised droplets of average diameter from about 10 to about 1000 nm, the droplets comprising the hydrophobic co-stabiliser and the monomer
(c) polymerising the monomer within the droplets.

2. A process according to the preceding claim, in which in step (a) the mixture is formed by mixing a first (aqueous) pre-mixture comprising the amphiphilic stabilising polymer and water with a second (organic) pre-mixture comprising the hydrophobic co-stabiliser and the α,β-ethylenically unsaturated monomer.

3. A process according to claim 2, in which a polymerisation initiator is incorporated (optionally dissolved) in the second pre-mixture.

4. A process according to claim 1 where the amphiphilic stabilising polymer is a polymer derived from a combination of hydrophobic monomers and hydrophilic monomers which comprise acid functions or functions leading thereto.

5. A process according to claim 1, where the amphiphilic stabilising polymer comprises copolymer(s) derived from styrene and maleic anhydride and/or from styrene, α-methyl styrene and acrylic acid.

6. A process according to claim 1, where the amphiphilic stabilising polymer has a solubility in the aqueous phase measured at 25° C. of at least about 1×10⁻² g/l.

7. A process according to claim 1, where the amount of amphiphilic stabilising polymer used is from about 0.5% to about 15% by weight relative to the total weight of α,β-ethylenically unsaturated monomer(s).

8. A process according to claim 1, where the hydrophobic co-stabiliser has a solubility in water, measured at 25° C., of less than about 5×10⁻⁵ g/l.

9. A process according to claim 1, where the hydrophobic co-stabiliser is selected from the group consisting of: C₁₂₋₁₄alkanes, C₁₂₋₁₄alcohols, C₁₈₋₂₂acrylates and mixtures thereof.

10. A process according to claim 1, where the hydrophobic co-stabiliser is used in an amount from about 0.05% to about 40% by weight based on the total weight of the mixture prepared in step (a).

11. A process according to claim 1 where the α,β-ethylenically unsaturated monomer has a solubility in water, measured at 25° C., of less than about 15%.

12. A process according to claim 1, where the α,β-ethylenically unsaturated monomer is selected from the group consisting of: styrenes, acrylates, methacrylates, vinyl and vinylidene halides, dienes, vinyl esters and mixtures thereof.

13. A process according to claim 1, where one or more water-soluble monomer(s) having a water solubility, measured at 25° C., higher than about 15% are added to the mixture of step (a) in an amount less than about 6% by weight of the total monomer(s).

14. A process according to claim 1, where one or more components that modify the pH are added to the mixture formed in step (a).

15. A process according to claim 1, where step (b) produces a mini-emulsion comprising stabilised droplets having an average diameter from about 50 nm to about 500 nm.

16. A process according to claim 1, where the high stress in step (b) is applied by equipment that produces localised high shear, optionally in combination with moderate bulk mixing.

17. A process according to claim 1, where the monomer within the droplets is polymerised in the presence of a free radical initiator.

18. A stable aqueous polymer dispersion obtained and/or obtainable indirectly and/or directly by a process as claimed in claim 1.

19. A stable aqueous polymer dispersion comprising a matrix of polymer particles formed from at least one α,β-ethylenically unsaturated monomer, the particles having an average diameter from about 10 to about 1000 nm, and homogenously dispersed with the polymer matrix there is: (i) at least one amphiphilic stabilising polymer of number average molecular weight (Mₙ) from about 800 to about 100,000 daltons and an acid number from about 50 to about 400 mg KOH/g; and (ii) optionally at least one hydrophobic co-stabiliser; where the polymer matrix:

20. (canceled)

21. A coating; film, adhesive and/or ink composition obtained and/or obtainable using a polymer dispersion as claimed in claim 18.

22. A coating; film, adhesive and/or ink composition obtained and/or obtainable using a polymer dispersion as claimed in claim 19.
